(19) United States
(12) Patent Application Publication
(10) Pub. No.: US 2012/0315460 A1
(43) Pub. Date: Dec. 13, 2012

(54) HYBRID CUSHIONING ARTICLES AND METHODS OF MAKING SAME

(76) Inventor: Roger LaFlamme, West Hartford, CT (US)

(21) Appl. No.: 13/493,716

(22) Filed: Jun. 11, 2012

Related U.S. Application Data
(60) Provisional application No. 61/520,385, filed on Jun. 9, 2011.

(51) Int. Cl. B32B 5/14; C09J 5/00

(52) U.S. Cl. 428/304.4; 156/306.6

(57) ABSTRACT

Cushioning material comprising air cell material may include a layer of air cell material, a layer of gel disposed on one side of the air cell material, and optionally on both sides of the air cell material, and two outer film layers, one on each side of the air cell material. The air cell material is disposed between the outer film layers, and the gel is disposed between at least one of the outer films and the air cell material.

### TECHNICAL FIELD

The present disclosure relates to a cushioning material and, in particular, to layered and/or hybrid cushioning materials.

### BACKGROUND

A wide variety of packing and/or cushioning materials are known, with various designs, constructions, properties and uses. Such materials include paper, cardboard, styrofoam peanuts, styrofoam panels, and bubble wrap. Other padding/cushioning materials include feather, fiberfill, polyethylene foam, and neoprene foam. Viscoelastic polymer gel has also been used as a cushion material, for example in wheelchair seat pads, shoe inserts, and motorcycle seats.

### SUMMARY

According to one embodiment of the invention, a hybrid cushioning material is provided which includes air cell material, such as bubble wrap, and polyurethane gel, or other elastomeric polymer. According to a preferred embodiment of the invention, a layer of air cell material is sandwiched between two outer film layers, and heat-sealed around the perimeter to create a bladder-like structure. The bladder-like structure, with the air-cell material preferably glued to one of the inside surfaces, is then filled with polyurethane gel through an opening in the bladder, and the opening is sealed. The hybrid air cell/gel material is then laid flat, preferably with pressure applied, to allow the gel to set to produce a flat finished assembly. The final assembly includes, in order from one side to the other, a first outer film layer, a layer of pressure sensitive adhesive, a layer of air cell material, a layer of polyurethane gel or other elastomeric polymer, and a second outer film layer. According to an alternative embodiment, the gel may be placed on both sides of the air cell material.

According to other embodiments of the invention, a layer of gel may be applied to a sheet of molded foam, and covered with top and bottom layers of outer film.

According to other embodiments of the invention, a layer of closed cell foam, such as polyethylene foam, and neoprene foam, may be added as a layer to the hybrid air-cell/gel material disclosed above.

According to another embodiment of the invention, a cushioning article is provided including a layer of textured foam, a layer of polyurethane gel on top of the textured foam, and a layer of outer film.

### DRAWINGS

Advantages, novel features, and uses of the disclosure will become more apparent from the following detailed description of non-limiting embodiments of the disclosure when considered in conjunction with the accompanying drawings, which are schematic and are not drawn to scale. In the Figures, which are not drawn to scale, each identical or substantially similar component that is illustrated in various Figures is typically represented by a single numeral or notation. For purposes of clarity, not every component is labeled in every Figure, nor is every component of each embodiment of the disclosure shown where illustration is not necessary to allow those of ordinary skill in the art to understand the disclosure. In the drawings:

FIG. 1 shows a cross-sectional side view of a section of one embodiment of a cushioning material according to the present invention, comprising a gel material integrated into an air cell material;

FIG. 1A shows a cross-sectional side view of a section of another embodiment of cushioning material according to the present invention, comprising a gel material integrated into an air cell material;

FIG. 1B shows a cross-sectional side view of a section of another embodiment of cushioning material according to the present invention, comprising a gel material integrated into an air cell material;

FIG. 1C shows the use of the cushioning material of FIG. 1A as a layer in a multi-layered mattress construction.

FIGS. 1D-1F are digital images of the cushioning material shown in FIG. 1A;

FIG. 2 shows a cross-sectional side view of a section of another exemplary cushioning material according to the present invention, comprising a gel material disposed over a molded foam material;

FIG. 2A shows the use of the cushioning material of FIG. 2 as a layer in a multi-layered mattress construction.

FIG. 3 shows a cross-sectional side view of a section of another exemplary cushioning material according to the present invention, comprising a foam material disposed over an air cell material;

FIG. 3A shows the use of the cushioning material of FIG. 3 as a layer in a multi-layered mattress construction.

FIGS. 3B-3C are digital images of the cushioning material shown in FIG. 3;

FIG. 4 shows a cross-sectional side view of a section of another exemplary cushioning material according to the present disclosure, comprising a gel material disposed over a corrugated foam material, with a film disposed over the gel;

FIG. 4A shows the use of the cushioning material of FIG. 4 as a layer in a multi-layered mattress construction.

FIG. 5 shows a cross-sectional side view of a section of another exemplary cushioning material according to the present disclosure, comprising an impact resistant or rate dependent molded foam material disposed over a support layer;

FIG. 5A shows the use of the cushioning material of FIG. 5 as a layer in a multi-layered mattress construction.

FIG. 6 shows a cross-sectional side view of a section of another exemplary cushioning material according to the present disclosure, comprising relatively large air cells formed in a foam support layer, with a film layer disposed over the foam to define the air cell compartments;

FIG. 6A shows the use of the cushioning material of FIG. 6 as a layer in a multi-layered mattress construction.

FIG. 7 shows cross-sectional side view of a section of another exemplary cushioning material according to the present disclosure, comprising multiple layers of air cell material disposed on top of each other, such that the air cells are disposed on top of each other;

FIG. 7A shows the use of the cushioning material of FIG. 7 as a layer in a multi-layered mattress construction.

FIG. 8 shows a cross-sectional side view of a section of an exemplary support member comprising a foam coating disposed on the exterior surface of a resilient material, such as spring steel; and

FIG. 8A shows the use of the cushioning material of FIG. 8 as a layer in a multi-layered mattress construction.

### DETAILED DESCRIPTION

The present disclosure is directed to improved cushioning materials and methods of making.

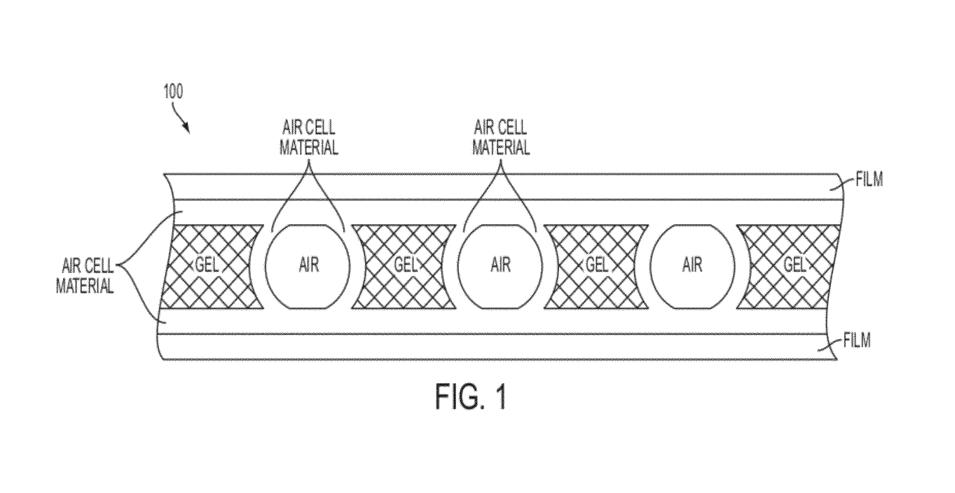

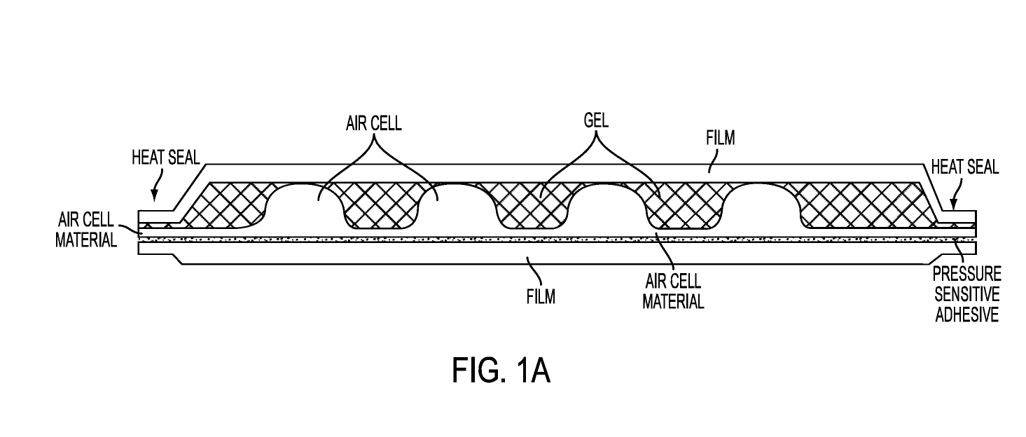

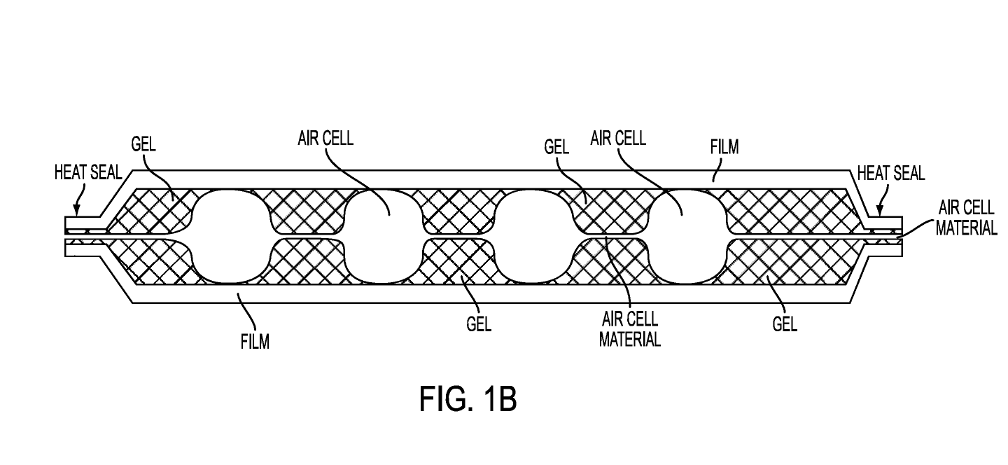

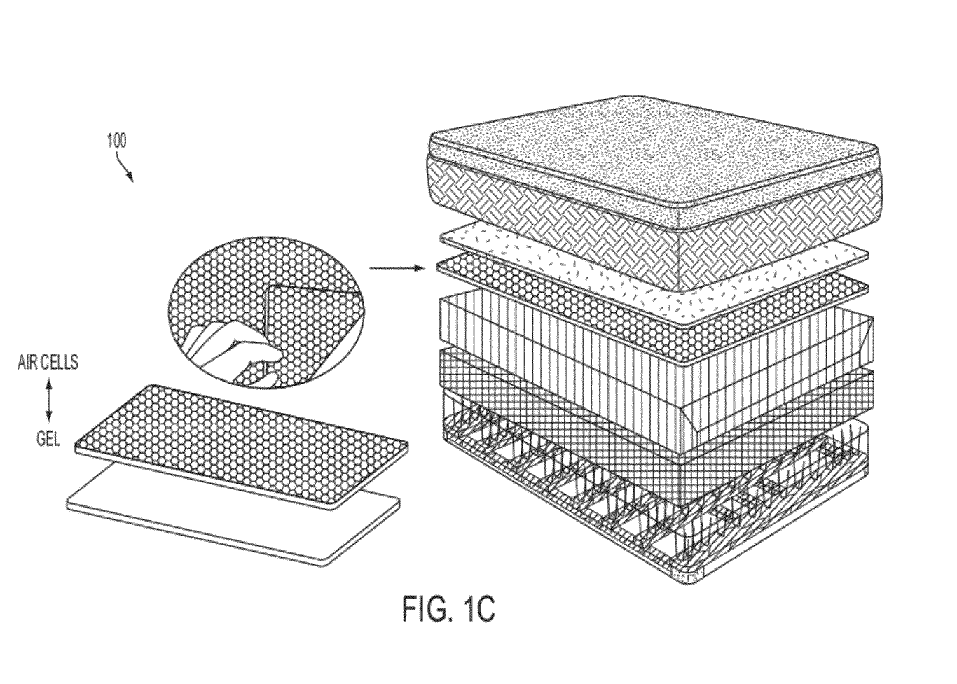

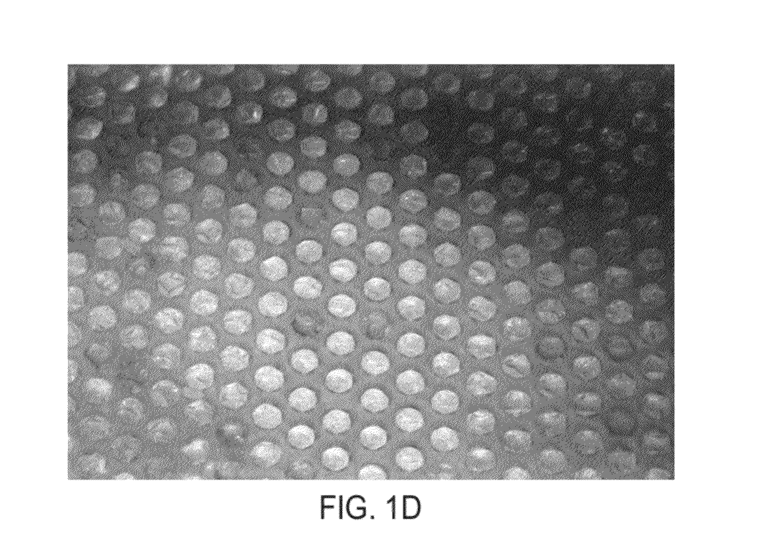

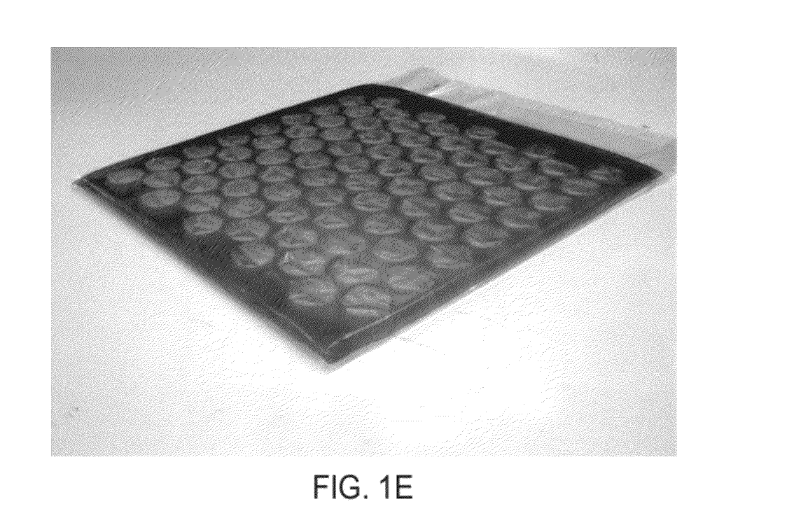

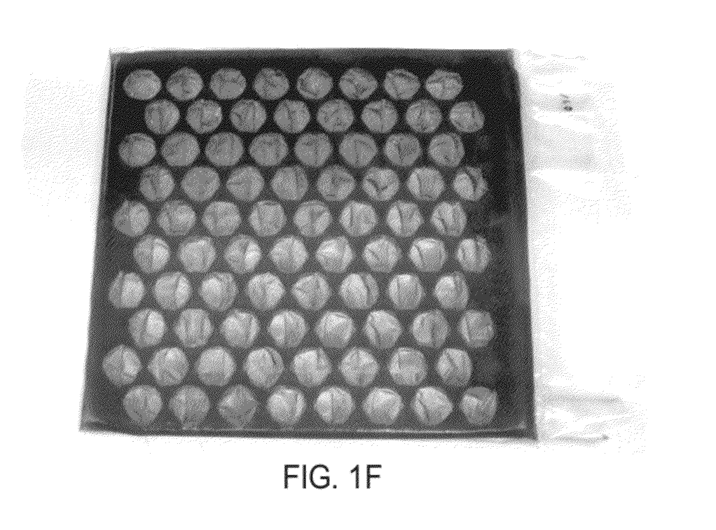

FIG. 1 shows a cross-sectional view of a section of one embodiment of an exemplary cushioning material 100 according to the present disclosure. Cushioning material 100 comprises a layer of air cell material having upper and lower surfaces, with a plurality of air cells disposed between the upper and lower surfaces, and gel material infused into the space between the air cells and between the upper and lower surfaces of the air cell material, to form a plurality of alternating air cells and gel cells disposed between the upper and lower surfaces. The air cell material is disposed between opposing barrier layers, which may be a film, such as TPE film.

One type of air cell material that can be used in the present cushioning material is the well known Bubble Wrap® brand air cell material, which is formed from two sheets of polyethylene (“PE”) resin film. The first sheet of the PE film is wrapped around a drum with holes punched in it, and suction is applied to the drum, drawing one the film into the holes, to form the bubbles, or cells. The second layer of PE film is then laminated over the first, so that when the two films are joined, they stick together and trap the air in the bubbles. As used herein, “air cell material” refers to the layers of film that define the air cells in the air cell material.

FIG. 1A shows a cross sectional view of another embodiment according to the invention comprising air cell material, opposing barrier layers, and a layer of gel disposed between one side of air cell material and one of the barrier layers.

FIG. 1B shows a cross sectional view of an embodiment according to the invention comprising air cell material, opposing barrier layers, and layers of gel disposed between each side of the air cell material and each adjacent barrier layer.

According to the embodiment of FIG. 1A, cushioning material comprising air cell material may comprise a layer of air cell material, a layer of gel disposed on one side of the air cell material (FIG. 1B shows the optional second layer of gel disposed on an opposite side of the air cell material), and two outer film layers, one on each side of the air cell material. According to this embodiment, the air cell material is disposed between the outer film layers, and the gel is disposed between one of the outer films and the air cell material (FIG. 1B shows the gel disposed on both sides of the air cell material). According to a preferred embodiment, the gel is present on only one side of the air cell material.

According to the embodiment of FIG. 1A, the “gel-on-one-side” embodiment, the outer film layer on one side of air cell material (the side opposite the gel-side) is fixed to the air cell material in a matter so as to prevent the gel from seeping onto that side of the air cell material. According to this embodiment, the pressure sensitive material may constitute a continuous adhesive layer between one side of the air cell material and the corresponding outer film layer. According to this embodiment, the outer film layer on the opposite side of the air cell material (the gel-side) may be affixed to the air cell material at selected points, e.g., at the top of one or more air cells, using pressure sensitive adhesive. Alternatively, the outer film layer on the gel-side of the article may be allowed to float on the gel, affixed to the air cell material and/or to the opposite side outer film only at the perimeter of the article.

In the case of the embodiment of FIG. 1B, in which the gel is disposed on both sides of the air cell material, the outer film layers may be affixed to portions of the air cell material by pressure sensitive adhesive in patterns that allow the gel to spread evenly between the outer film layer and the air cell material.

An article according to the embodiment shown in FIG. 1A may be manufactured as follows. Two sheets of outer layer film are cut to a size sufficient to overlap a selected piece of air cell material. A layer of pressure sensitive adhesive is applied to one side of one of the sheets of outer layer film, and the air cell material is laid down upon the layer of pressure sensitive adhesive which has been applied to one side of the first sheet of outer layer film. The second sheet of outer layer film is laid on top of the air cell material. The perimeter of the article is heat sealed, sealing the perimeters of the outer layers of film to one-another, and optionally heat sealing the perimeter of the air cell material between them. At the conclusion of the heat-sealing step, an opening is left between the top outer film layer and the air cell material, which opening is used in the following step as a gel-fill port. The article is then filled with urethane gel or other elastomer and the gel or other elastomer is spread evenly across the air cell material and between the air cell material and the top layer of the outer film layer. The gel-fill port is then heat sealed, and a weight is placed on the gel-filled article to apply a constant pressure as the gel cures to insure flat finished assemblies.

Examples of the cushioning material made according to these steps are shown in FIG. 1A and in the photograph of FIGS. 1D-1F.

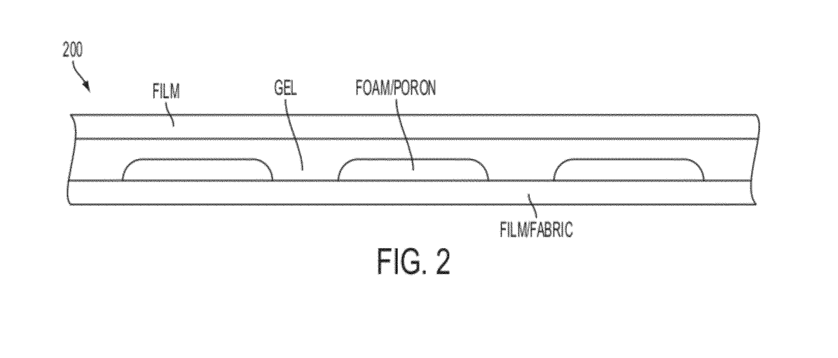

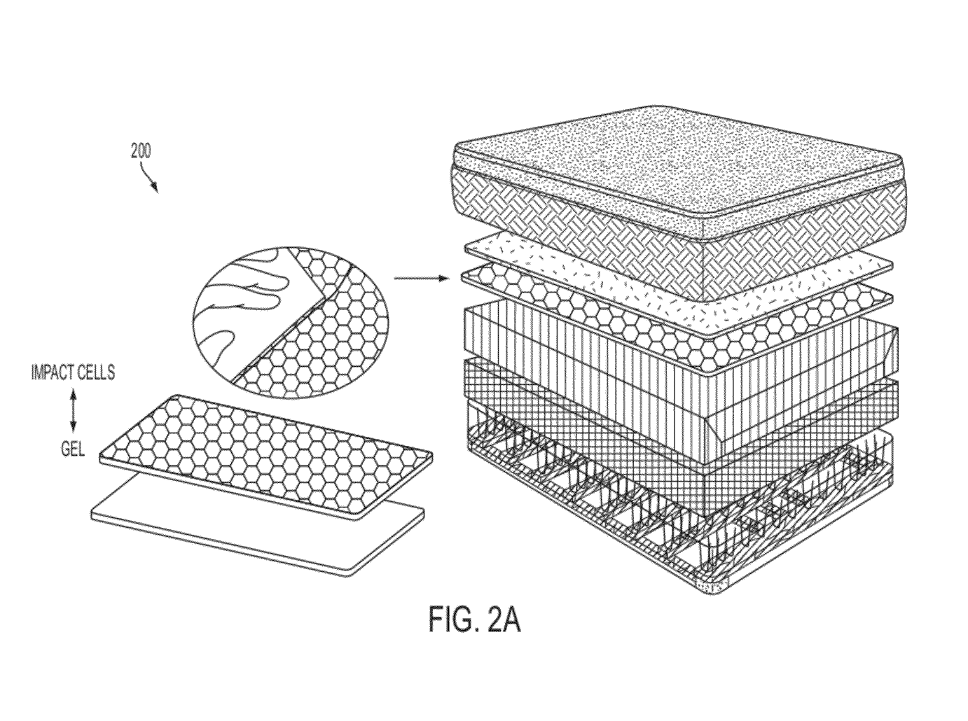

FIG. 2 shows a cross-sectional view of a section of another embodiment of an exemplary cushioning material 200 according to the present disclosure. Cushioning material 200 comprises foam regions defined in or supported on a support layer, which may be fabric or film. The foam may be any type of open or closed cell foam including, but not limited to, memory foam, rate dependent foam, combinations of the foregoing, and the like. A layer of gel is disposed over the foam regions, and a barrier layer, such as a TPE film layer, is disposed over the gel, opposite the support layer.

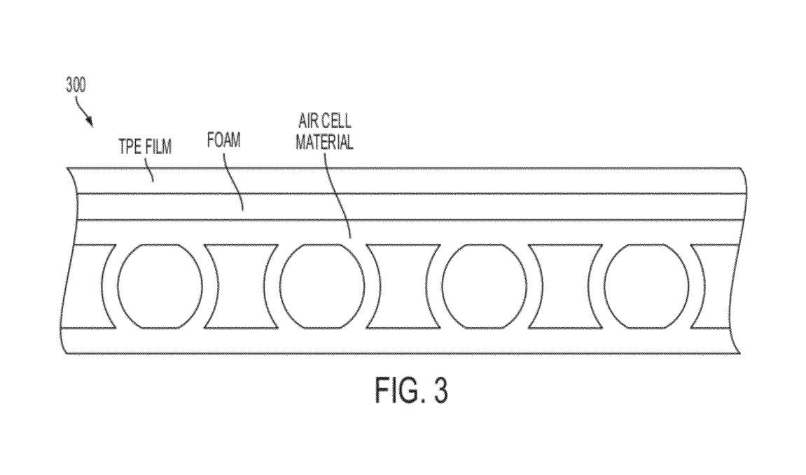

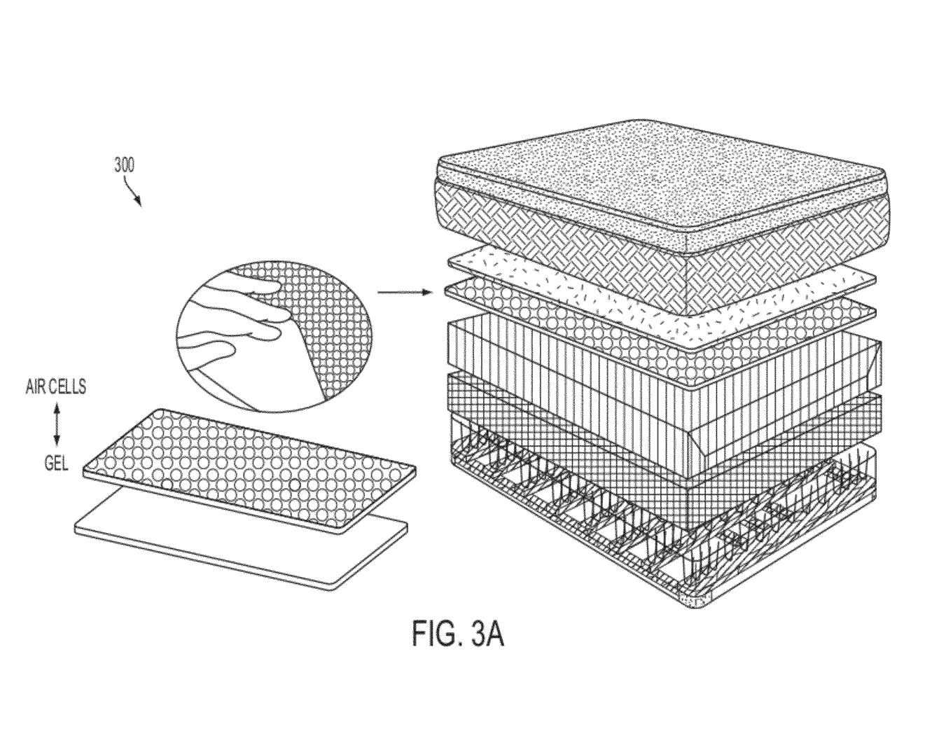

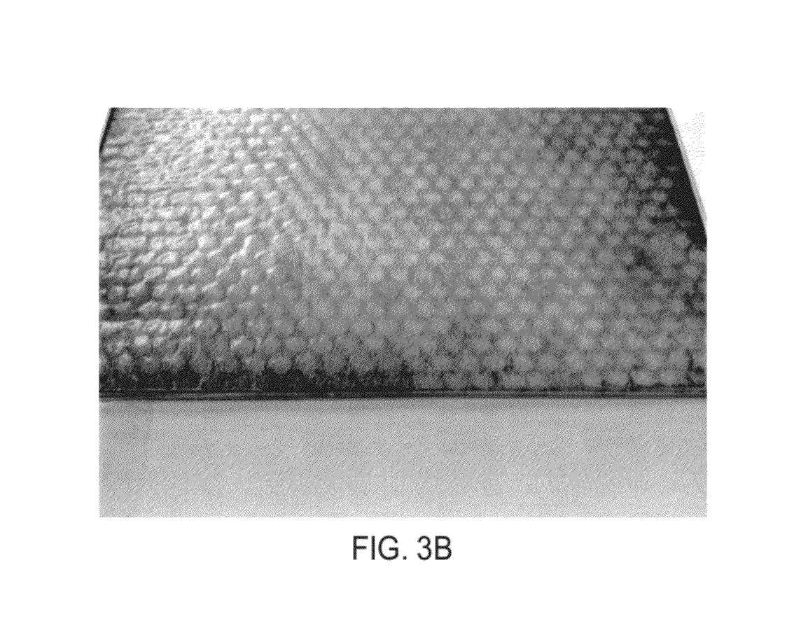

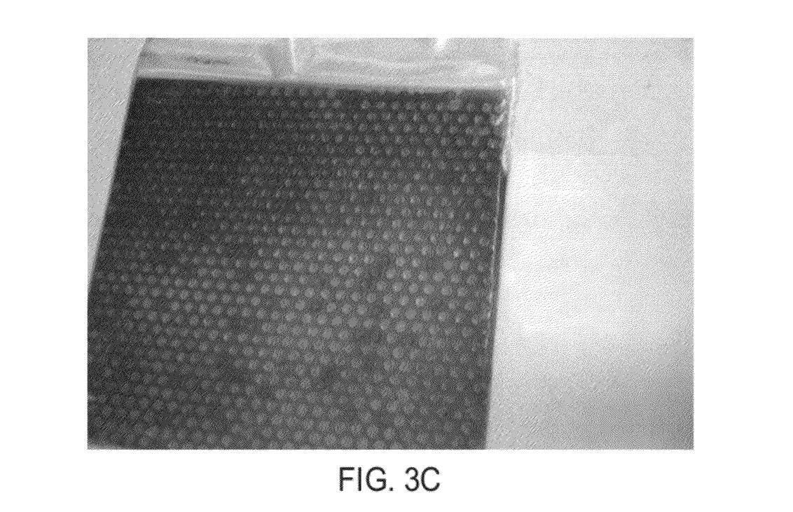

FIG. 3 shows a cross-sectional view of a section of another embodiment of an exemplary cushioning material 300 according to the present disclosure. Cushioning material 300 comprises a layer of air cell material having upper and lower surfaces, with a plurality of air cells disposed between the upper and lower surfaces, with free space disposed around the air cells. In the present embodiment, a layer of foam is disposed on the upper surface of the air cell material and a barrier layer, such as a TPE film layer, is disposed adjacent to the foam layer, opposite the air cell material.

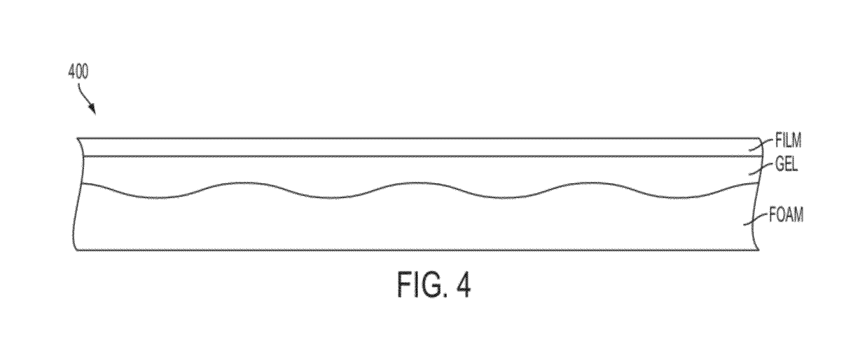

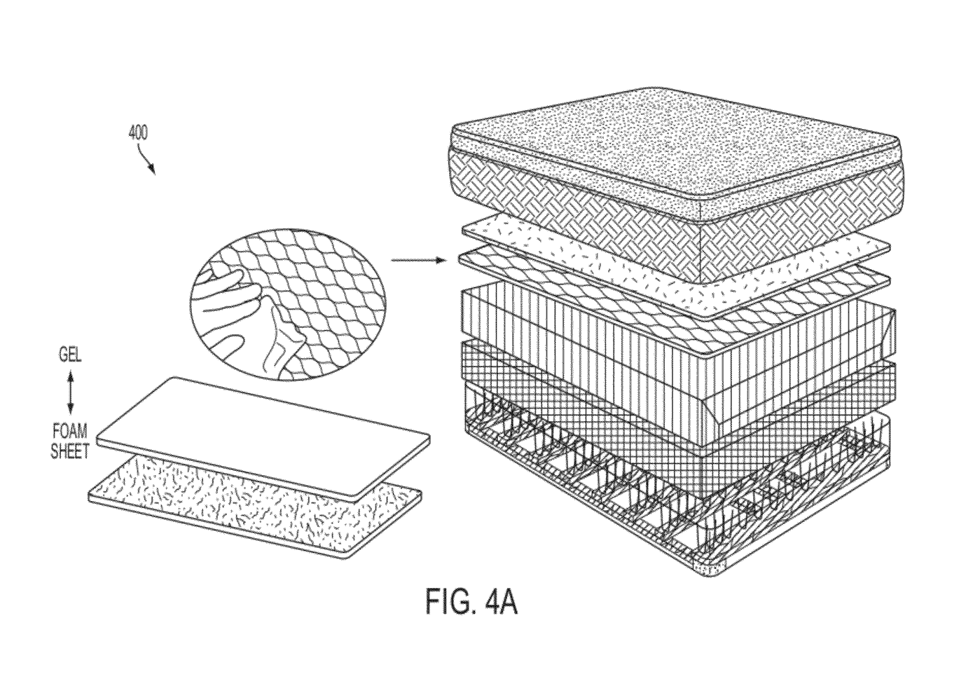

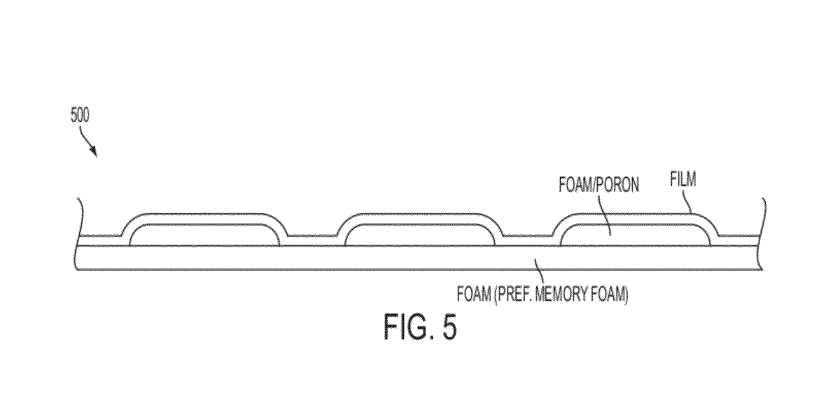

FIG. 4 shows a cross-sectional view of a section of another exemplary embodiment of an exemplary cushioning material 400 according to the present disclosure, which comprises a foam layer with a “corrugated” upper surface, and gel layer disposed adjacent to the corrugated upper surface, and a barrier layer disposed adjacent to the gel layer, and opposite the foam layer. In the present embodiment, if the foam is an open-cell foam, the gel material can at least partially penetrate the upper surface of the foam material. For practical purposes, due to the weight of the gel materials, it can be useful to minimize the depth of penetration of the gel into the foam while balancing the desired characteristics of the final product, e.g., softness, total weight, and the like. For example, for products such as mattress toppers, it can be desirable to minimize the overall weight of the topper. Therefore, tailoring the depth of penetration of the gel precursor into the foam layer can provide the desired softness, while minimizing the contribution of the gel to the overall weight of the topper. For example, it can be desirable for a mattress topper to comprise a gel-infused layer of about 1/16 inch to about 1/8 inch, and such a depth can be achieved by applying about 1-1.1 gram of gel precursor per square inch to the upper surface of the foam layer 12, which provides a gel infused layer 14 of about 1/16 inch. Disposing the gel precursor onto the foam layer 12 can be performed manually, or the process can be automated. For example, the gel precursor can be disposed onto the foam layer using a variety of techniques such as, but not limited to, a roller, pouring, spraying, and/or the like.

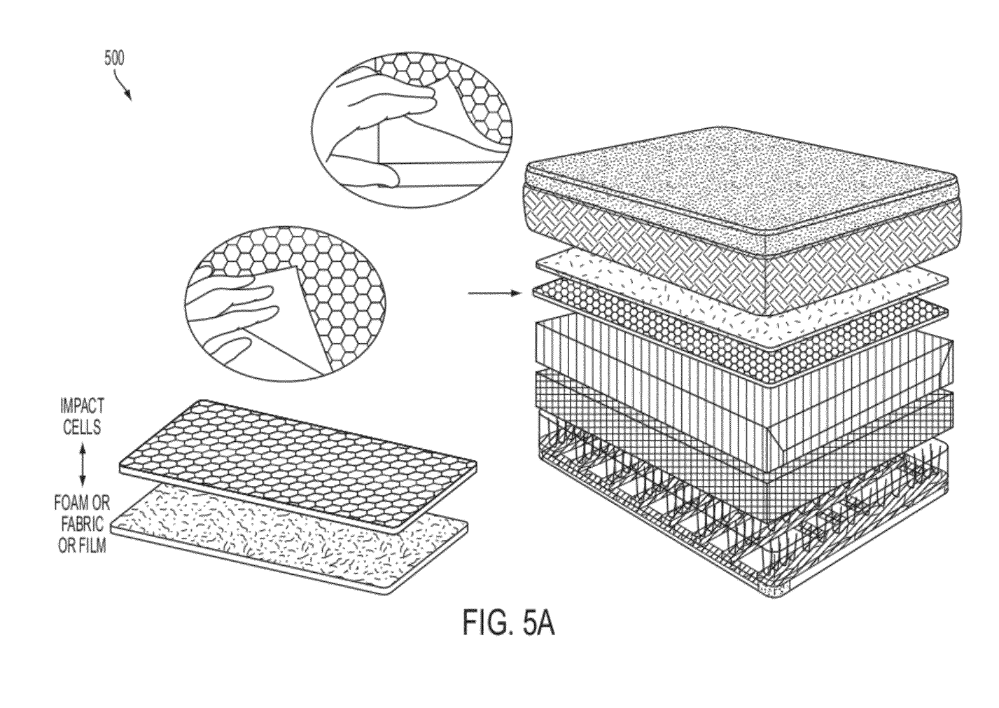

FIG. 5 shows a cross-sectional view of a section of another embodiment of an exemplary cushioning material 500 according to the present disclosure. Cushioning material 500 comprises foam regions defined in or supported on a foam support layer, which may be any type of open or closed cell foam including, but not limited to, memory foam, rate dependent foam, combinations of the foregoing, and the like. A layer of gel is disposed over the foam regions, and a barrier layer, such as a TPE film layer, is disposed over the gel, opposite the support layer.

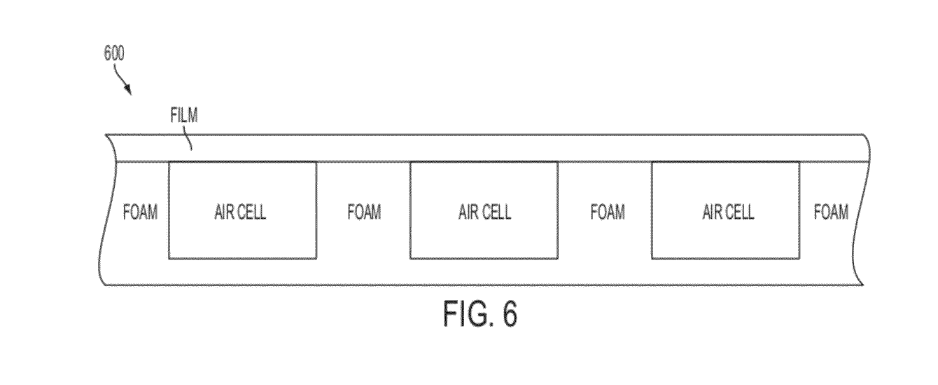

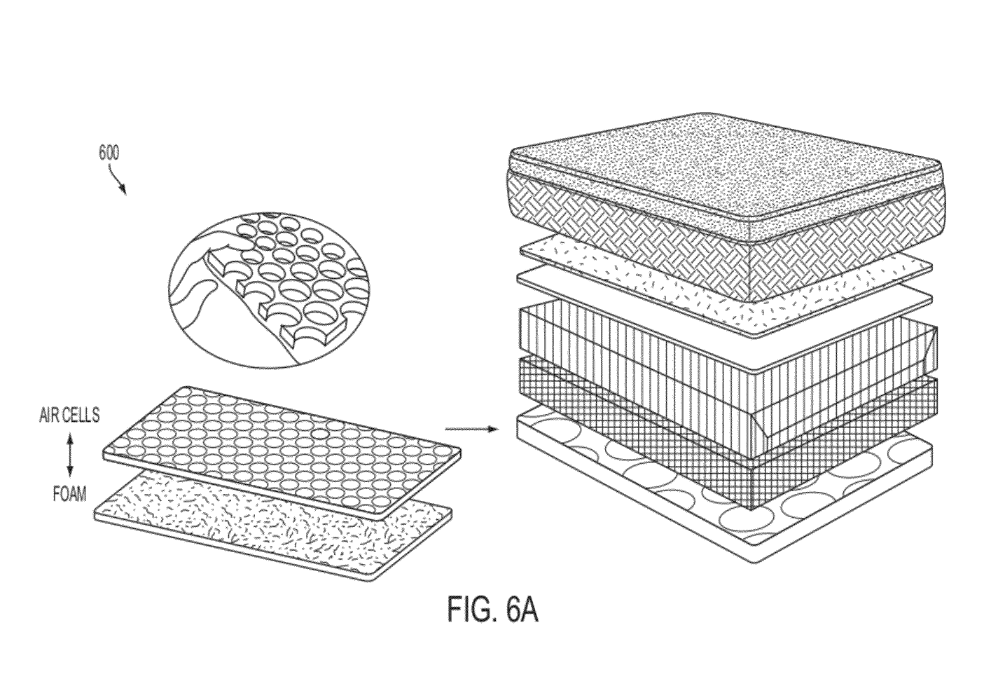

FIG. 6 shows a cross-sectional view of a section of one embodiment of an exemplary cushioning material 600 according to the present disclosure. Cushioning material 600 comprises a layer of foam having upper and lower surfaces, with a plurality of cells formed in the upper surface, and a barrier layer, which may be a film, such as TPE film, disposed on the upper surface of the foam, to define a plurality of air cells bounded by the foam and the barrier layer.

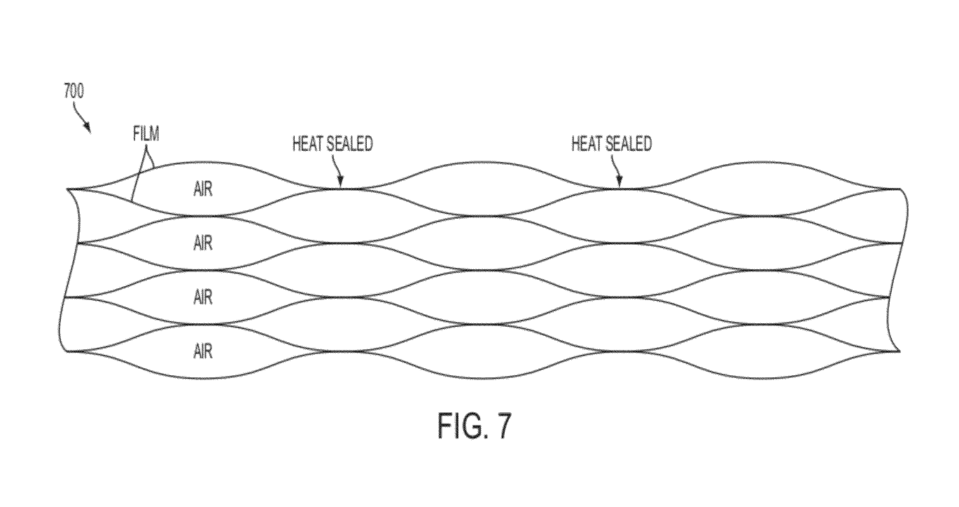

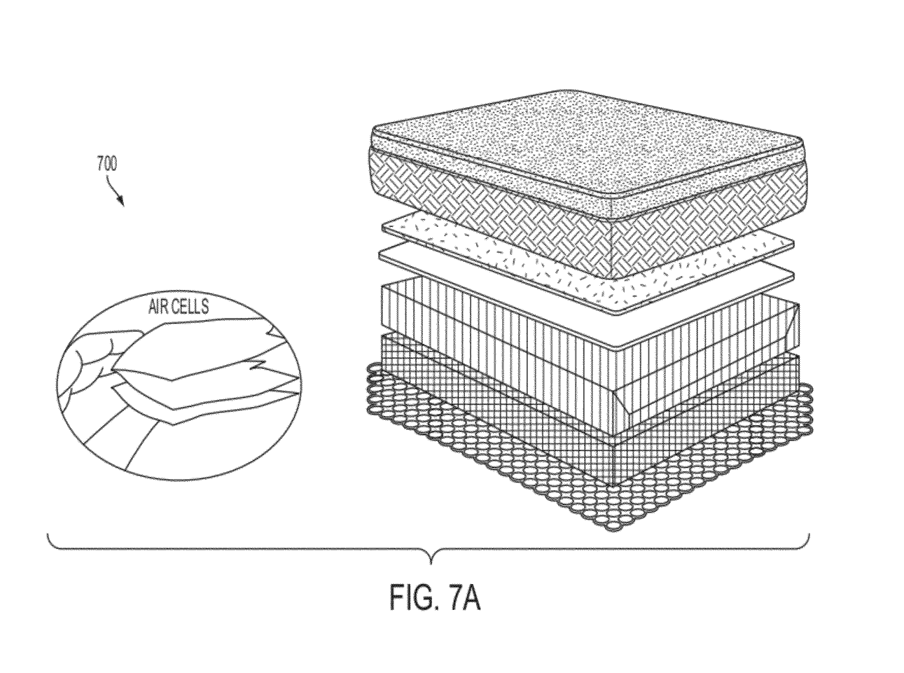

FIG. 7 shows a cross-sectional view of a section of one embodiment of an exemplary cushioning material 700 according to the present disclosure. Cushioning material 700 comprises multiple layers of an air cell material disposed in adjacent relation, such that the air cells are disposed adjacent to each other. The air cell material can be formed by laminating or heat sealing air into pockets between opposing film layers, and the cushioning material 700 can be formed by heat sealing the multiple layers of air cell material together, where needed or desired.

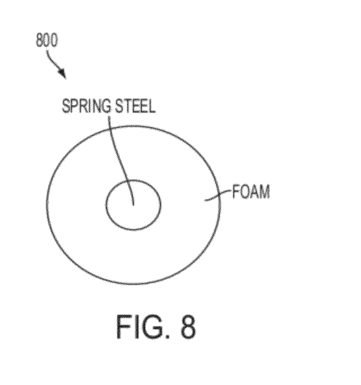

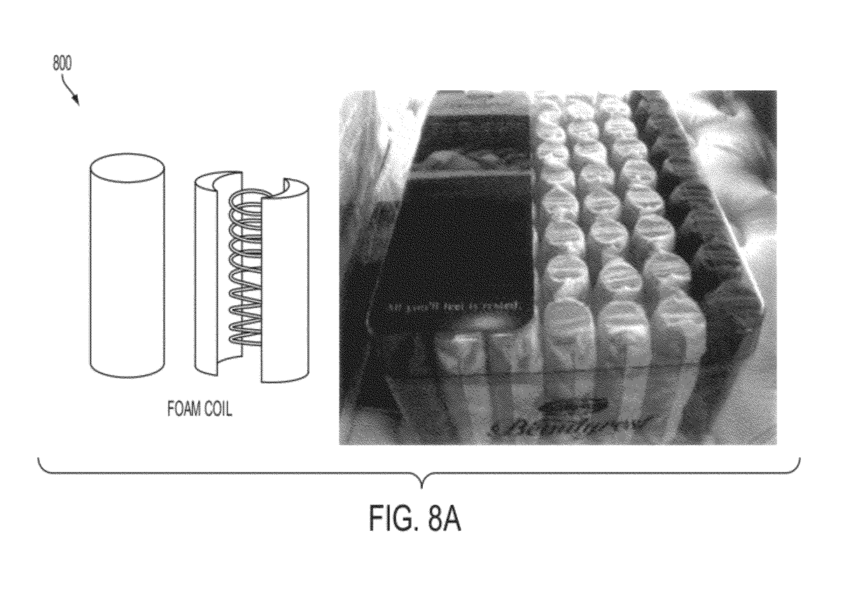

FIG. 8 shows a cross-sectional view of a section of a resilient support member 800 that can be used in various cushioning materials. Support member 800 can comprise a layer of foam disposed on the exterior surface of a resilient material, such as spring steel. The support member 800 can be used, for example, to form coil springs for use in mattresses and/or mattress foundations.

The foregoing cushioning materials can facilitate the manufacture of a variety of products that can be desirable for aesthetics and/or to minimize wear and/or friction. The cushioning materials and methods can be used to form articles and/or regions of articles, comprising any size, thickness or geometry. The size, thickness, geometry, softness, and adhesive strength of the articles and/or portions of the articles can be selected to optimize the conditions for which they are designed. In addition, the present cushioning materials can be used to replace gel and/or foam in any type of product.

Some exemplary embodiments of articles in which the cushioning materials can be used include, but are not limited to, padding for medical devices and equipment (e.g., wheelchair seat pads, wheelchair padding, medical pads, hospital gurney pads, operating table pads, positioning pads); padding for furniture (e.g., upholstery padding, furniture cushions, furniture pads); padding for athletic equipment and devices (e.g., athletic cushions, sports and athletic padding, gymnastic mats); padding for recreational equipment and devices (e.g., camping and sleeping mats); padding for apparel (e.g., bra straps, shoulder pads, shoe linings, boot linings); padding for household goods (e.g., anti-fatigue mats, mattress pads, mattress covers, mattress foundations; mattress “toppers;” the pillow-top portion of pillow-top mattresses, pillows, and the like); padding accessories (e.g., briefcase shoulder straps, computer carrying cases, purses, gloves, and the like); pet beds; and the like.

In some instances, it may be desirable to be able to adhere the upper and/or lower surface of cushioning material to various surfaces. For example, optionally, an adhesive (not illustrated) may be disposed on one or more of the upper and/or lower surfaces of the foregoing cushioning materials. If necessary, the adhesive can be supported by a release and/or support layer (not illustrated). In all of the foregoing, some possible adhesives can comprise pressure sensitive adhesives, thermoplastic adhesives, and the like, as well as combinations comprising at least one of the foregoing. One example of such a material is available from 3M as product number 7026.

In some instances, the gel and/or gel infused layer may comprise sufficient adhesive strength to be adhered to a surface in the absence of a separate adhesive. In such instances, the barrier layer may be replaced with a release and/or support layer (not illustrated). Optionally, the release and/or support layer can comprise a release coating, such as silicone, which can assist in the manual release of the barrier layer from an underlying layer.

A variety of materials can be used in the foregoing methods to make the foregoing cushioning materials. Foam layers can comprise any material capable of being infused with another material (for example, capable of being infused with a polymeric gel material). Examples of suitable materials that can be used for the foam layer include, but are not limited to, open cell or closed cell foamed plastic materials, non-wovens, mesh materials (such as metal mesh, plastic mesh, and the like), spacer fabric, and combinations comprising at least one of the foregoing. Examples of open-cell foamed plastic materials include, but are not limited to, shape memory foam, polyurethane foam, latex foam, and the like, and combinations comprising at least one of the foregoing. Specific examples of polyurethane foams include, but are not limited to, polyester and polyether polyurethane foam, frothed polyurethane foams, and combinations comprising at least one of the foregoing. One example of a frothed polyurethane foam is manufactured under the name PORON®. One example of a shape-memory foam is manufactured under the name TEMPUR-PEDIC®. The foam material can comprise any thickness, density and/or cell size, depending upon the application for which it is intended.

The gel layer can comprise, for example, any material comprising sufficient structural integrity to be formed into predetermined shapes, including polymeric materials and foam polymeric materials; and that is capable of withstanding the environment in which it is intended to be used, without substantial degradation. The hardness of the material (e.g., the gel materials) can be selected to provide articles and/or regions of articles with a predetermined hardness, which can be tailored for specific cushioning and/or wear resistance applications. For example, gel can comprise a durometer ranging from about 5 Shore 000 to about 88 Shore D. The hardness of the gel can be determined using a tool such as a durometer.

Examples of suitable polymeric materials for the gel include, but are not limited to, thermosetting polymeric materials, elastomeric polymeric materials, thermoplastic materials, including thermoplastic elastomeric materials, and combinations comprising at least one of the foregoing. Some possible polymeric materials include, but are not limited to, polyurethane, silicone, and/or the like, and combinations comprising at least one of the foregoing materials. Examples of other materials include, but are not limited to, cushioning materials, frothed foams, and the like.

Formation of the gel precursor can take place by a variety of methods known to those of skill in the art. For example, formation of a polyurethane gel can comprise reacting suitable pre-polymeric precursor materials e.g., reacting a polyol and an isocyanate in the presence of a catalyst.

In some embodiments, it can be desirable for the gel to have sufficient softness and/or pliability to provide comfort against a body. In such instances, gel can comprise a durometer ranging from about 0.01 Shore 00 to less than or equal to about 70 Shore A, more particularly less than 70 Shore 00, more particularly still less than 60 Shore 00.

The barrier layer can comprise any material capable of providing sufficient elasticity to prevent tearing and/or stretching when a force is applied thereto; sufficient structural integrity to be formed into predetermined shapes; and that is capable of withstanding the environment in which it is intended to be used, without substantial degradation. In addition, in some embodiments, it can be desirable for the barrier layer to be capable of providing at least some moisture transmission in order to minimize or prevent the local build-up of moisture. The barrier layer also can be selected to facilitate the handling of the gel layer, which can comprise adhesive characteristics in some instances. Therefore, the barrier layer can be selected to comprise a relatively non-tacky surface and a relatively smooth feel to the human touch. The barrier layer can comprise an elongation of about 25 percent (%) to about 1500%, more particularly about 200% to about 1000%, and more particularly still about 300% to about 700%. It should be understood that the modifier “about” used in connection with a quantity is inclusive of the stated value and has the meaning dictated by the context (e.g., includes the degree of error associated with measurement of the particular quantity). Some possible materials for the barrier layer include polyolefins, polystyrenes, PVC, latex rubber, and thermoplastic elastomers (TPEs), and/or the like, and combinations comprising at least one of the foregoing materials. Some possible TPE materials include polyurethane, silicone, and/or the like, and combinations comprising at least one of the foregoing materials. Examples of materials that are suitable for the barrier layer include, but are not limited to, Vacuflex, Hytrel and PEBAX, and the like.

The barrier layer can comprise any thickness. For practical purposes it has been found that thinner layers can provide improved hand-feel, while thicker layers can provide increased durability. Therefore, it can be desirable to use the thinnest barrier layer possible in order to prevent punctures in the barrier layer. When the gel is tacky, puncturing the barrier layer can expose the underlying tacky material of the gel, making it difficult to handle. Barrier layer can comprise a thickness ranging from about 0.2 milli-inch (hereinafter “mil”) to about 5 mil, more particularly from about 0.5 mil to about 3 mil, and more particularly still from about 0.75 mil to about 2 mil. It should be understood that thicker or thinner materials may be used, depending upon the application for which the material is intended. For example, when the cushioning material is used to make a mattress topper and/or the pillow portion of a pillow-top mattress, the amount of support provided by the cushioning material can be varied by varying the thickness of, among other things, the barrier layer.

As noted above, barrier layer can be applied as a sheet of material. In the form of a sheet, and especially when the barrier layer is relatively thin, the barrier material can be very flexible and may wrinkle and/or fold very easily during handling. Therefore, if desired, the barrier layer also can comprise a support layer (not illustrated), which assists in handling the material.

One or more of the foregoing layers can comprise one or more additives such as, but not limited to, modifiers, coloring agents, stabilizers, phase changing materials, ultraviolet inhibitors, and/or active agents as well as combinations comprising at least one of the foregoing. The concentration of the additive can be varied depending on the desired characteristics of the cushioning material and/or the layer. Suitable active agents can comprise tolnaftate, undecenoic acid, allylamines, chlorine, copper, baking soda, sodium omadine, zinc omadine, azoles, silver, and/or the like, and combinations comprising at least one of the foregoing. For example, silver can provide an antifungal/antibacterial effect. For purposes of economy and effectiveness, it has been found advantageous to include active agents, when used, in the thinnest layer, because disposing such agents in the thinnest layer allows the use of reduced total amounts of the agents to achieve similar effective concentrations in comparison to thicker layers, thereby reducing costs associated with the additives. Also, it can be desireable to dispose such agents in the outermost layer of the article i.e., the body contacting regions, rather than in regions remote from the user, which can increase the effectiveness of the agents. One possible phase changing material can comprise phase changing microspheres (available under the product name Outlast), which contain materials that can change phases at near body temperature. As a result, heat energy can be stored in the barrier layer, resulting in a product that can feel cool or warm. In one illustrative embodiment, the barrier layer can comprise an active agent such as silver, to minimize or prevent the formation of fungus, bacteria and/or parasites. One possible barrier layer comprising such an active agent is Vacuflex 18411AG, available from Omniflex, Inc. Such an active agent can be desirable in products such as mattresses, as discussed above.

In any of the foregoing embodiments, the use of a colored or patterned layer (e.g., a colored and/or patterned fabric layer) in combination with a transparent gel can provide what appears to be a colored or patterned gel article. This can create an article with much more color variations than would be possible with simply using colored or pigmented gel. The use of patterned fabrics or metallic sheen fabrics or other variations in the aesthetic of layer can impart these aesthetics to the gel article; such aesthetics would be difficult or impossible to impart to the gel article by pigmenting the gel or printing the gel article. This process also offers a potential economic advantage to coloring or printing the gel.

If desired, additional optional layers can be disposed between any of the layers described above in connection with any embodiment of the foregoing cushioning materials. Optional layers can comprise a variety of synthetic and/or non-synthetic materials including, but not limited to, paper, fabric, plastic film, and/or the like, as well as cushioning and/or combinations comprising at least one of the foregoing. When the layer comprise a fabric layer, the fabric can be knit, woven, non-woven, synthetic, non-synthetic, and combinations comprising at least one of the foregoing. Disposing a fabric layer as layer can be advantageous because it can trap and disperse air bubbles that may otherwise form in or between the layers, resulting in a better appearance for the final molded products. The optional layers also can comprise color, embossing, graphics and/or indicia, including text. The color, graphics and/or indicia disposed on layer can be transmitted through other layers when they are formed from colorless and/or transparent materials, which can be desirable for aesthetic and cost reasons. In addition, if desired, layer can be fluid-permeable. “Fluid-permeable,” as used herein, means that the material from which layer is formed is open to passage or entrance of a fluid material, such as the gel precursor, sometimes resulting in the formation of another gel layer adjacent to another layer.

While the disclosure has been described with reference to an exemplary embodiment, it will be understood by those skilled in the art that various changes may be made and equivalents may be substituted for elements thereof without departing from the scope of the disclosure. For example, although described herein with reference to foamed materials, in particular plastic or polymeric foamed materials, it should be understood that the method can be applied to other materials capable of being infused with another material such as, but not limited to, wovens, non-wovens, metal mesh, and the like. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. An article of manufacture comprising:
a first outer film,
a layer of air cell material;
a first layer of gel material disposed between said first outer film and said layer of air cell material;
a second outer film disposed on the side of the article opposite said first outer film;
wherein edges of the first and second outer films are sealed to one-another to enclose the gel and the layer of air cell material.

2. An article of manufacture according to claim 1, further comprising a layer of pressure sensitive adhesive between said second outer film and said layer of air cell material and fixing said second outer film to said layer of air cell material.

3. An article of manufacture according to claim 1, further comprising a second layer of gel material between said second outer film and a side of said air cell material opposite said first layer of gel material.

4. A method of making a hybrid cushion material, comprising:
fixing a layer of air cell material inside an outer film layer;
applying gel material between at least one side of the air cell material and a portion of said outer film layer;
sealing edges of the outer film layer to itself to provide a sealed compartment containing the gel and the air cell material;
allowing the gel to cure.

5. A method of making a hybrid cushion material according to claim 4, wherein the outer film layer comprises a first sheet of outer film and a second sheet of outer film.

6. A method of making a hybrid cushion material according to claim 4, further comprising applying a layer of pressure sensitive adhesive between a first portion of said outer film layer and a first side of said air cell material.
